(19) United States
(12) Patent Application Publication
(10) Pub. No.: US 2019/0319515 A1
(43) Pub. Date: Oct. 17, 2019

(54) MAGNETIC REPULSION GENERATOR

(71) Applicant: Cole Evan Haggarty, Coventry, RI (US)

(72) Inventor: Cole Evan Haggarty, Coventry, RI (US)

(21) Appl. No.: 16/385,385

(22) Filed: Apr. 16, 2019

Related U.S. Application Data
(60) Provisional application No. 62/658,246, filed on Apr. 16, 2018.

(51) Int. Cl. H02K 7/18; H02K 1/27

(52) U.S. Cl. CPC H02K 7/1823; H02K 53/00; H02K 1/2706

(57) ABSTRACT

A magnetic repulsion generator includes a base having a circular shape with an outer edge and an inner edge. The base is made of a non-ferrous metal and acts as magnetic shielding. An array of electromagnetic field enhancers are disposed around the outer edge of the base and a plurality of magnets are disposed around the inner edge of the base. A rotating shaft is coupled to an electrical generator. A plurality of arms are disposed within the base and extend radially from the rotating shaft. Each of the plurality of arms include a magnet repulsed by the plurality of magnets.

### CROSS-REFERENCE TO RELATED APPLICATION

This application claims the benefit of priority of U.S. provisional application No. 62/658,246, filed Apr. 16, 2018, the contents of which are herein incorporated by reference.

### BACKGROUND OF THE INVENTION

The present invention relates to a power generator and, more particularly, to a generator utilizing magnetic repulsion.

Fossil fuel is a general term for buried combustible geologic deposits of organic materials, formed from decayed plants and animals that have been converted to crude oil, coal, natural gas, or heavy oils by exposure to heat and pressure in the earth's crust over hundreds of millions of years.

The use of fossil fuels raises serious environmental concerns. The burning of fossil fuels produces around 21.3 billion tonnes of carbon dioxide (CO₂) per year, but it is estimated that natural processes can only absorb about half of that amount, so there is a net increase of 10.65 billion tonnes of atmospheric carbon dioxide per year (one tonne of atmospheric carbon is equivalent to 44/12 or 3.7 tonnes of carbon dioxide.) Carbon dioxide is one of the greenhouse gases that enhances radiative forcing and contributes to global warming, causing the average surface temperature of the Earth to rise in response, which the vast majority of climate scientists agree will cause major adverse effects.

As can be seen, there is a need for cleaner energy sources that do not produce greenhouse gases.

### SUMMARY OF THE INVENTION

In one aspect of the present invention, a magnetic repulsion generator comprises a base comprising a circular shape having an outer edge and an inner edge, wherein the base is made of a non-ferrous metal; an array of electromagnetic field enhancers disposed around the outer edge of the base; a plurality of magnets equally spaced apart and disposed around the inner edge of the base; a rotating shaft coupled to an electrical generator; and a plurality of arms disposed within the base and extending radially from the rotating shaft, each of the plurality of arms comprising a magnet repulsed by the plurality of magnets, wherein rotational energy of the rotating shaft is converted into electrical energy by the electrical generator, and a portion of the electrical energy is fed to the array of electromagnetic field enhancers.

In another aspect of the present invention, a magnetic repulsion generator comprises a base comprising a circular shape having an outer edge and an inner edge, wherein the base is made of a non-ferrous metal; an array of electromagnetic field enhancers disposed around the outer edge of the base; a plurality of magnets equally spaced apart and disposed around the inner edge of the base at an angle away from a direction of rotation of the rotating shaft; a rotating shaft coupled to an electrical generator; and a plurality of arms disposed within the base and extending radially from the rotating shaft, each of the plurality of arms comprising a magnet repulsed by the plurality of magnets, wherein the rotating shaft is initially rotated by an outside energy source, rotational energy of the rotating shaft is converted into electrical energy by the electrical generator, and a portion of the electrical energy is fed to the array of electromagnetic field enhancers.

These and other features, aspects and advantages of the present invention will become better understood with reference to the following drawings, description and claims.

### BRIEF DESCRIPTION OF THE DRAWINGS

FIG. 1 is a schematic perspective view of an embodiment of the present invention;

FIG. 2 is a schematic front view of an embodiment of the present invention;

FIG. 3 is a schematic front view of an embodiment of the present invention shown in use; and

FIG. 4 is a flowchart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a generator that converts magnetic repulsion into usable energy. The present invention harnesses the repulsive properties of permanent magnets and electromagnets to drive a spiral gearset and in turn drive a turbine. The present invention feeds a fraction of the produced power back into the system and uses rotational inertia to further drive the system.

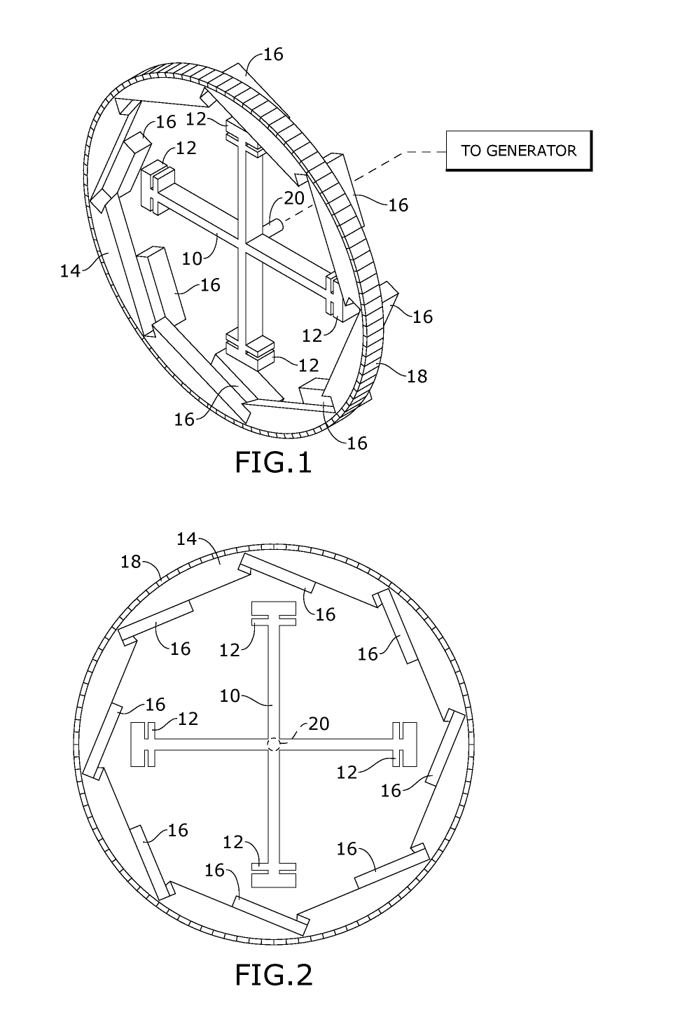

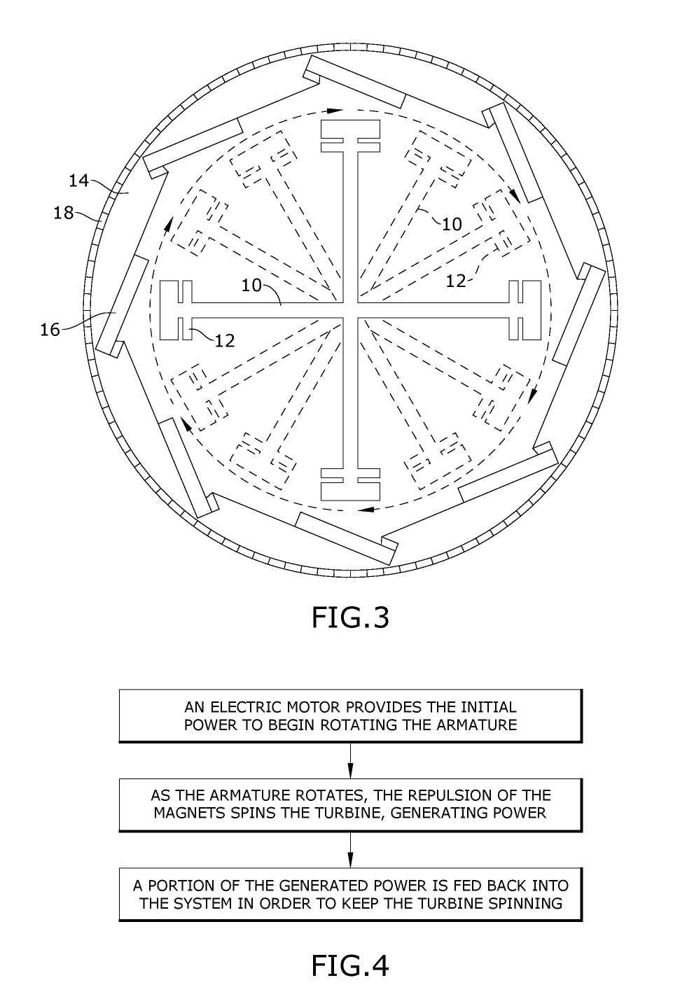

Referring to FIGS. 1 through 4, the present invention includes a magnetic repulsion generator. The magnetic repulsion generator includes a base 14 having a circular shape with an outer edge and an inner edge. The base 14 is made of a non-ferrous metal and acts as magnetic shielding. An array of electromagnetic field enhancers 18 are disposed around the outer edge of the base 14 and a plurality of magnets 16 are disposed around the inner edge of the base 14. The magnetic repulsion generator further includes a rotating shaft 20 coupled to an electrical generator. A plurality of arms 10 are disposed within the base 14 and extend radially from the rotating shaft 20. Each of the plurality of arms 10 include a magnet 12 repulsed by the plurality of magnets 16.

The rotating shaft 20 may be initially rotated by an outside energy source. For example, an electric motor provides initial rotational energy. The plurality of magnets 16 and the magnets 12 of the plurality of arms 10 repulse each other which drives the rotating shaft 10 and turbine. The base 14 (magnetic shielding) keeps the magnetic fields from interacting until interaction can further urge the plurality of arms 10 to rotate. The rotational energy of the rotating shaft 20 is converted into electrical energy by the electrical generator. A portion of the electrical energy is fed to the array of electromagnetic field enhancers 18 and a portion of the electrical energy is fed to a load. The more power fed to the array of electromagnetic field enhancers 18, the stronger the magnetic field, which in turn produces a higher repulsion speed.

As mentioned above, the base 14 is a magnetic shielding. The base 14 may have a ring shape and separates the plurality of magnets 16 from the array of electromagnetic field enhancers 18. In certain embodiments, the plurality of magnets 16 are directly coupled to the inner edge of the base 14 and the array of electromagnetic field enhancers 18 are directly coupled to the outer edge of the base 14. The base 14 may be made of any non-ferrous metal, such as aluminum, non-ferrous steel, or the like. The base 14 could be cast or forged in the desired shape.

The plurality of magnets 16 of the base 14 and the plurality of magnets 12 of the arms 10 may include neodymium or other strong permanent magnets. The array of electromagnetic field enhancers 18 may include a hollow electromagnet surrounding a permanent magnet. In certain embodiments, the plurality of magnets 16 of the base 14 are each disposed at an angle away from a direction of rotation of the rotating shaft 20. The angle of the magnets 16 is 45 degrees relative to a vector extending perpendicular from a point of the inner edge.

The arms 12 of the present invention are evenly spaced apart. Each of the arms 12 include distal ends. The magnets 12 are coupled to the distal ends of the arms 12. In certain embodiments, the plurality of arms 12 may include four arms evenly spaced apart. In such embodiments, the plurality of magnets 16 may include eight magnets 16. However, the present invention may include more or less arms 12 and magnets 16.

It should be understood, of course, that the foregoing relates to exemplary embodiments of the invention and that modifications may be made without departing from the spirit and scope of the invention as set forth in the following claims.

What is claimed is:

1. A magnetic repulsion generator comprising:
a base comprising a circular shape having an outer edge and an inner edge, wherein the base is made of a non-ferrous metal;
an array of electromagnetic field enhancers disposed around the outer edge of the base;
a plurality of magnets equally spaced apart and disposed around the inner edge of the base;
a rotating shaft coupled to an electrical generator; and
a plurality of arms disposed within the base and extending radially from the rotating shaft, each of the plurality of arms comprising a magnet repulsed by the plurality of magnets, wherein
rotational energy of the rotating shaft is converted into electrical energy by the electrical generator, and
a portion of the electrical energy is fed to the array of electromagnetic field enhancers.

2. The magnetic repulsion generator of claim 1, wherein the rotating shaft is initially rotated by an outside energy source.

3. The magnetic repulsion generator of claim 1, wherein the plurality of magnets are each disposed at an angle away from a direction of rotation of the rotating shaft.

4. The magnetic repulsion generator of claim 3, wherein the angle is dependent on a strength of magnetism of the plurality of magnets.

5. The magnetic repulsion generator of claim 1, wherein the plurality of arms comprises four arms and the plurality of magnets comprise eight magnets.

6. The magnetic repulsion generator of claim 1, wherein the non-ferrous metal is aluminum.

7. A magnetic repulsion generator comprising:
a base comprising a circular shape having an outer edge and an inner edge, wherein the base is made of a non-ferrous metal;
an array of electromagnetic field enhancers disposed around the outer edge of the base;
a plurality of magnets equally spaced apart and disposed around the inner edge of the base at an angle away from a direction of rotation of the rotating shaft;
a rotating shaft coupled to an electrical generator; and
a plurality of arms disposed within the base and extending radially from the rotating shaft, each of the plurality of arms comprising a magnet repulsed by the plurality of magnets, wherein
the rotating shaft is initially rotated by an outside energy source,
rotational energy of the rotating shaft is converted into electrical energy by the electrical generator, and
a portion of the electrical energy is fed to the array of electromagnetic field enhancers.

8. The magnetic repulsion generator of claim 7, wherein the angle is dependent on a strength of magnetism of the plurality of magnets.

9. The magnetic repulsion generator of claim 7, wherein the plurality of arms comprises four arms and the plurality of magnets comprises eight magnets.

10. The magnetic repulsion generator of claim 7, wherein the non-ferrous metal is aluminum.
